(19) United States
(12) Patent Application Publication
(10) Pub. No.: US 2025/0130209 A1
(43) Pub. Date: Apr. 24, 2025

(54) INDUSTRIAL METHOD FOR ISOLATING AN ANALYTE FROM A LIQUID MIXTURE

(71) Applicant: BLUTECH APS, Hillerød (DK)

(72) Inventors: Michael PALSSON, Hillerød (DK); Kenneth William HARLOW, Frederiksberg (DK)

(21) Appl. No.: 18/683,161

(22) PCT Filed: Aug. 11, 2022
(86) PCT No.: PCT/EP2022/072577

§ 371 Date: Feb. 12, 2024

(30) Foreign Application Priority Data
Aug. 13, 2021 (DK) PA202100804
Jan. 24, 2022 (DK) PA202200063
Jun. 9, 2022 (DK) PA202200544

(51) Int. Cl. G01N 30/38; B01D 15/18

(52) U.S. Cl. CPC G01N 30/38; B01D 15/1807

(57) ABSTRACT

The present invention relates to a method for separating an analyte from a liquid mixture, said method comprises the steps of (i) providing at least one chromatographic support, wherein the at least one chromatographic support comprises a ligand capable of binding the analyte in the liquid mixture; (ii) loading a first portion of the liquid mixture to the at least one chromatographic support; (iii) optionally, the at least one chromatographic support is subjected to a washing step; and (iv) adding a first elution buffer to the at least one chromatographic support, providing an eluate fraction comprising the analyte, wherein at least part of the eluate fraction comprising the analyte provided in step (iv) is recirculated through the at least one chromatographic support.

### TECHNICAL FIELD OF THE INVENTION

The present invention relates to a method for providing a chromatographic separation system suitable for large scale separation of an analyte present in a liquid mixture. In particular, the present invention relates to a method and a system for separating an analyte, e.g. a protein or an oligosaccharide from a liquid mixture obtained from milk or plants on an industrial scale.

### BACKGROUND OF THE INVENTION

Since chromatographic processes was introduced to the market for separating analytes in a liquid mixture, the technology has got high interests because it may show high specificity for certain analytes compared to membrane filtration techniques. However, the costs associated with developing the adsorbent materials and the ligands, where specific ligands are needed for specific purposes, combined with the slow flowrates and low binding capacities are among some of the drawback of the chromatographic processes compared to membrane filtration. Therefore, chromatographic processes have mainly been used for preparatory work or for high value products where purity is an issue.

Over the years there have been increased interest in improving productivity of the chromatographic processes and one technique that has been developed is moving bed and simulating moving bed (SMB) which has improved productivity of the chromatographic processes significantly and made it possible to run processes more continuously.

Moving bed chromatography provided a continuous system for separating proteins and involved a carousel like structure comprising several columns (at least two) where switching between flows through the columns are provided in a time-controlled manner; in particular, by changing the switch time of the columns at a constant flow. This carrousel type continuous chromatography system has some technical drawbacks due to the fact that all columns switch simultaneously from one position to the next as the columns in moving bed systems are not controlled separately, since holding time in the column, whether it being loading, wash, elution, or regeneration, may be very different if properly optimized.

These issues lead to the development of SMB systems which also have at least two (often more) identical chromatographic supports, which are connected to each other and to a mobile phase pump (e.g. a feed loading pump, a washing buffer pump, or an elution buffer pump). This connection may be provided by a multi-port valve. The intention of the SMB system is that the specific streams (feed stream, water stream, buffer stream, CIP steam may be dedicated to a specific chromatographic support when required by the separation cycle.

The connections in a SMB system are configured in such a way that:
a) all columns will be connected in series, forming a single continuous loop;
b) typically, between each column there will be provisions for four process streams: incoming feed mixture, exiting purified fast component, exiting purified slow component, and incoming solvent or eluent; and
c) each process stream (two inlets and two outlets) will proceed in the same direction after a set time.

The advantage provided by SMB may be that an industrial scale chromatographic system may be established, which may be operated continuously, requiring less resin (adsorbent material) and less solvent than batch chromatography. The continuous operation facilitates operation control and integration into production plants.

However, the disadvantage of SMB is that an enormous space is required for tanks and chromatographic supports, high buffer consumption, high water consumption and high CIP consumption.

Hence, an improved chromatographic system and an improved chromatographic method for isolating an analyte from a liquid mixture having an improved productivity would be advantageous, and in particular a more efficient chromatographic system and an efficient chromatographic method for isolating an analyte from a liquid mixture providing improved productivity compared to the presently available systems and methods, in particular in connection with expanded bed adsorption chromatography (EBA), where the space requirements are reduced, the buffer consumption, the water consumption and chemical consumption during CIP, and/or the time at the membrane is reduced would be advantageous.

### SUMMARY OF THE INVENTION

Thus, an object of the present invention relates to an improved chromatographic system and an improved chromatographic method for isolating an analyte from a liquid mixture having an improved productivity.

In particular, it is an object of the present invention to provide a chromatographic system, in particular an expanded bed adsorption chromatographic system (EBA system), and an improved chromatographic method, in particular an expanded bed adsorption chromatographic method (EBA method) for isolating an analyte from a liquid mixture that solves the above mentioned problems of the prior art with productivity, space requirement for tanks and chromatographic supports, high buffer consumption, water consumption and CIP consumption.

Thus, one aspect of the invention relates to a method for separating an analyte from a liquid mixture, said method comprises the steps of:
(i) providing at least one chromatographic support, wherein the at least one chromatographic support comprises a ligand capable of binding the analyte in the liquid mixture;
(ii) loading a first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
   wherein at least part of the eluate fraction comprising the analyte provided in step (iv) is recirculated through the at least one chromatographic support.

A further aspect of the present invention relates to a method for separating an analyte from a liquid mixture, said method comprising the step of:
(i) providing at least one chromatographic support, wherein the at least one chromatographic support comprises a ligand capable of binding the analyte in the liquid mixture;
(ii) loading first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
(v) loading a second (or further) portion of the liquid mixture to the at least one chromatographic support;
(vi) optionally, the at least one chromatographic support is subjected to a washing step; and
(vii) adding a second (or further) elution buffer to the at least one chromatographic support, providing a second (or further) eluate fraction comprising the analyte,
(viii) optionally repeating steps (v)-(vii),
   wherein the second (and further) elution buffer added in (vii) comprises at least part of the previous eluate fraction comprising the analyte.

Another aspect of the present invention relates to a method for separating an analyte from a liquid mixture, said method comprises chromatographic separation of the analyte from a liquid mixture by subjecting the analyte bound to a ligand in the one or more chromatographic support, to an elution buffer providing an eluate fraction comprising the analyte, wherein at least part of the eluate fraction is used as elution buffer.

Yet another aspect of the present invention relates to a chromatographic system comprising one or more chromatographic support, the one or more chromatographic support comprises at least one inlet and at least one outlet, the at least one outlet is in fluid connection with at least one eluate tank, wherein the at least one eluate tank comprises a recirculation system in fluid connection with the at least one inlet of the one or more chromatographic support.

Another aspect of the present invention relates to a chromatographic system comprising one or more chromatographic support, the one or more chromatographic support comprises at least one inlet and at least one outlet, the at least one outlet is in fluid connection with at least one eluate tank, and at least one harvest tank for receiving the harvest fraction, wherein the at least one eluate tank comprises a recirculation system in fluid connection with the at least one inlet of the one or more chromatographic support and wherein the harvest tank may be in fluid connection with at least one membrane-system for removing at least part of the eluate buffer from the analyte and said at least one membrane-system is in fluid connection with the at least one inlet of the one or more chromatographic support.

### DESCRIPTION OF THE FIGURES

FIG. 1 shows a method and a chromatographic system according to the present invention for separating an analyte from a liquid mixture, as described herein below. The system illustrated in FIG. 1 shows 5 different scenarios of the present invention:
Scenario A: demonstrates and elution of analyte fraction from the chromatographic support following an initial loading of liquid mixture to the chromatographic support, which also resemble the traditional way of handling the chromatographic support;
Scenario B: demonstrates the idea of the present invention where the eluate fraction is recycled for eluting further immobilised analytes from the chromatographic support;
Scenario C: demonstrates another embodiment of the idea of the present invention where the eluate fraction is directly recycled from the outlet of the chromatographic support to the inlet of the chromatographic support and reintroduced into the chromatographic support allowing additional immobilised analyte to be eluted from the chromatographic support.
Scenario D: demonstrates an elution procedure when the eluate fraction has been saturated with analyte; and
Scenario E: demonstrate further concentration and recycling of elution buffer from the eluate fraction, e.g. the saturated eluate fraction, to the elution buffer tank.

Each of the scenarios in FIG. 1 shows 3 different buffer tanks, where the first buffer tank (1-I) may comprises a washing buffer, the second buffer tank (1-II) may comprises an elution buffer, and the third buffer tank (1-III) may comprise a regeneration buffer. The system and method may comprise several second buffer tanks (1-II) comprising different elution buffers, e.g. used for sequential elution of different analytes.

During the first scenario, scenario A, a liquid mixture comprising the analyte(s) of interest may be loaded on the chromatographic support (3) and the analyte fraction or analyte fractions are allowed to bind to the chromatographic support (3). The chromatographic support (3) and the immobilised analyte(s) may be subjected to a washing step by loading a washing buffer from the first buffer tank/the washing buffer tank (1-I) to the chromatographic column (3), whereby impurities may be removed from the chromatographic support (3). Following the optional washing step, the chromatographic support (3) may be subjected to an elution buffer, which is loaded from the second buffer tank/the elution buffer tank (1-II) to the chromatographic support (3) providing an eluate fraction comprising the analyte. The eluate fraction may preferably be collected in a first eluate tank (2-I). If separate eluate fractions are provided from the same chromatographic support (3), e.g. by sequential elution, the second analyte fraction may be collected in a second eluate tank (2-II). Before a new portion of liquid mixture is loaded on to the chromatographic support, the chromatographic support (3) may be subjected to a regeneration step, by loading regeneration buffer from the third buffer tank/the regeneration buffer tank (1-III) to the chromatographic support (3), and the chromatographic support is ready for a new circle.

In the second scenario, scenario B, a second load of liquid mixture is loaded on the chromatographic support (3) and the immobilised analyte/analytes are subjected to a washing step as described above, followed by an elution step, where the eluate fraction collected in the eluate tank (2-I) is loaded on the column allowing the immobilised analyte fraction to be liberated from the chromatographic support (3) and collected in the eluate tanks (2-I and/or 2-II). In an embodiment of the present invention the method described in this scenario B may be repeated 2 times, such as 3 times, e.g. 4 times, such as 5 times, e.g. 6 times. Preferably, the scenario B is repeated until the eluate fraction may be saturated or substantially saturated. In an embodiment of the present invention, the concentration of analyte in the eluate fraction (correlated to a standard volume) is at least 25% higher, such as at least 50% higher, e.g. at least 75% higher, such as at least 90% higher, such as at least 100% higher, e.g. at least 110% higher, such as at least 150% higher, e.g. at least 175% higher.

In the third scenario, scenario C, a liquid mixture comprising the analyte(s) of interest may be loaded on the chromatographic support (3) and the analyte fraction or analyte fractions are allowed to bind to the chromatographic support (3), as described in the first scenario, scenario A. Following an optional washing step, the chromatographic support (3) may be subjected to an elution buffer, which is loaded from the second buffer tank/the elution buffer tank (1-II) to the chromatographic support (3) providing an eluate fraction comprising the analyte. The eluate fraction comprising the analyte may be recirculated through the at least one chromatographic support, preferably directly recycled, from the outlet of the chromatographic support to the inlet of the chromatographic support and reintroduced into the chromatographic support allowing additional immobilised analyte to be eluted from the chromatographic support. In an embodiment of the present invention the method described in this scenario C may be repeated at least 2 times, such as at least 3 times, e.g. at least 4 times, such as at least 5 times, e.g. at least 6 times. Preferably, the scenario C is repeated until the eluate fraction may be saturated or substantially saturated. In an embodiment of the present invention, the concentration of analyte in the eluate fraction (correlated to a standard volume) is at least 25% higher, such as at least 50% higher, e.g. at least 75% higher, such as at least 90% higher, such as at least 100% higher, e.g. at least 110% higher, such as at least 150% higher, e.g. at least 175% higher.

In the fourth scenario, scenario D, the eluate fraction (2-I) used for eluting the analyte may be saturated or substantially saturated and the remaining immobilised analyte fraction may be flushed with new buffer (1-II), or un-saturated elution (not shown in the figure), in order to collect the entire eluate fraction from the chromatographic support (3).

In the fifth scenario, scenario E, the eluate fraction, the saturated/substantially saturated eluate fraction may be subjected to a further treatment, by loading the eluate fraction from the eluate tank (2-I) to e.g. a membrane filtration unit, such as a microfiltration unit (MF) and/or an ultrafiltration unit (UF), resulting in an increased concentration of the analyte fraction in the retentate and a purified or substantially purified liquid fraction (an elution buffer permeate) which may be recycled to the buffer tank and used as elution buffer, preferably as a new elution buffer and/or a unsaturated elution buffer. The elution buffer permeate may be sterilised before being added to the second buffer tank/the elution buffer tank (1-II).

FIG. 2 shows another method and a chromatographic system according to the present invention for separating an analyte from a liquid mixture. FIG. 2 shows a chromatographic support (3) which has been loaded with a liquid mixture and the immobilised analyte/analytes may be subjected to a washing step as described above.

Following the washing step the chromatographic support may be subjected to an elution step, where an eluate buffer may be provided from the buffer tank (1) and the eluate fraction (6) may be provided. The concentration of the analyte in the eluate fraction (6) may be continuously determined and until the concentration reach a certain limit (which may be set by the operator) the eluate fraction (6) may be collected as recirculated fraction (8), in the eluate tank (2) and recycled through the chromatographic support (3) one or more times. When the concentration in the eluate fraction (6) of the analyte reach (and goes above) the certain limit a valve redirects the elution fraction to a harvest fraction (9) to a harvest tank (4). When the concentration of the analyte in the eluate fraction (6) again goes below the certain limit the valve redirects the elution fraction (6) back as the recirculated fraction (8) to the eluate tank (2). The more times the eluate fraction is recycled (as recirculated fraction (8)) to the eluate tank (2) and through the chromatographic support (3) the higher the concentration of the analyte becomes in the recirculated fraction (8)—this is illustrated in subsection (A) and is shown in FIG. 3.

The harvest fraction (9) may preferably be collected in the harvest tank (4) and via the fluid connection (10) the harvest fraction may be directed from the harvest tank (4) to a membrane treatment (5). However, in an embodiment of the present invention the harvest tank (4) may be omitted directing the harvest fraction (9) directly to a membrane treatment (5). The more times the eluate fraction is recycled (as recirculated fraction (8)) to the eluate tank (2) and through the chromatographic support (3) the higher the concentration of the analyte becomes in the harvest fraction (9) this is illustrated in subsection (B) and is shown in FIG. 5.

The membrane treatment (5) may include ultrafiltration and/or diafiltration obtaining a pure desalted product comprising the separated analyte. The membrane treatment may also regenerate, or substantially regenerate, the elution buffer providing a regenerated elution buffer. The regenerated elution buffer obtained from the membrane treatment may be recirculated to the elution buffer tank and/or to the one or more chromatographic support. Preferably, the regenerated elution buffer may be mixed with the recirculated fraction obtained from the eluate fraction

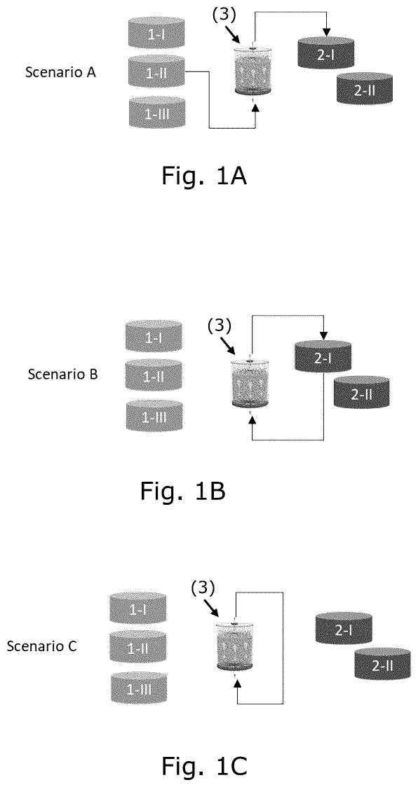

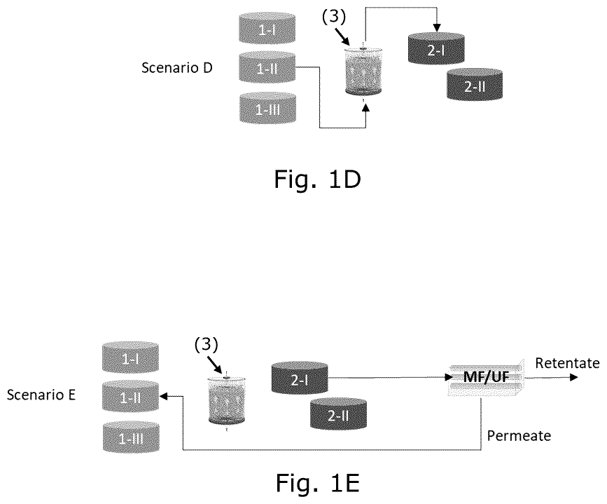

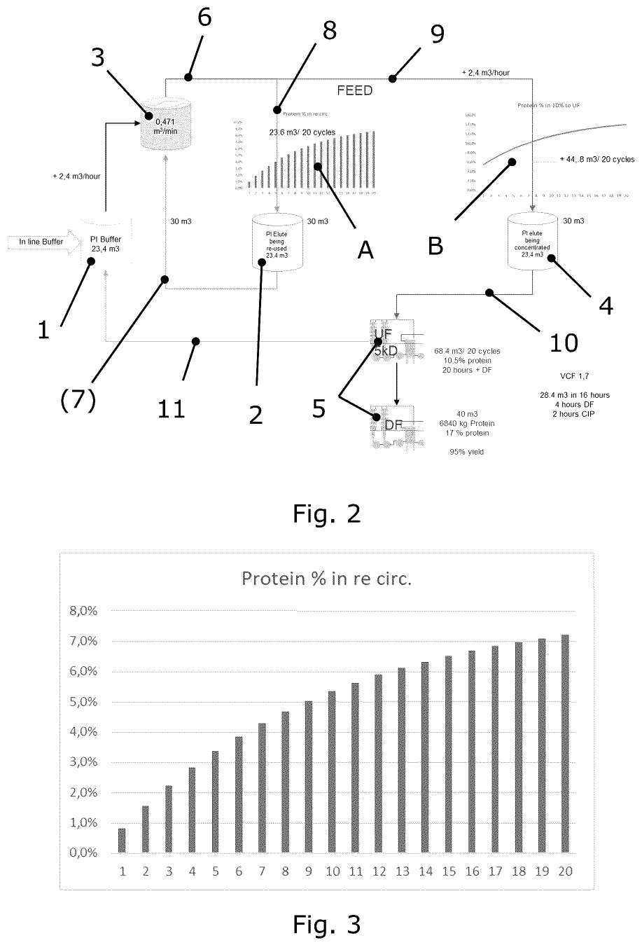

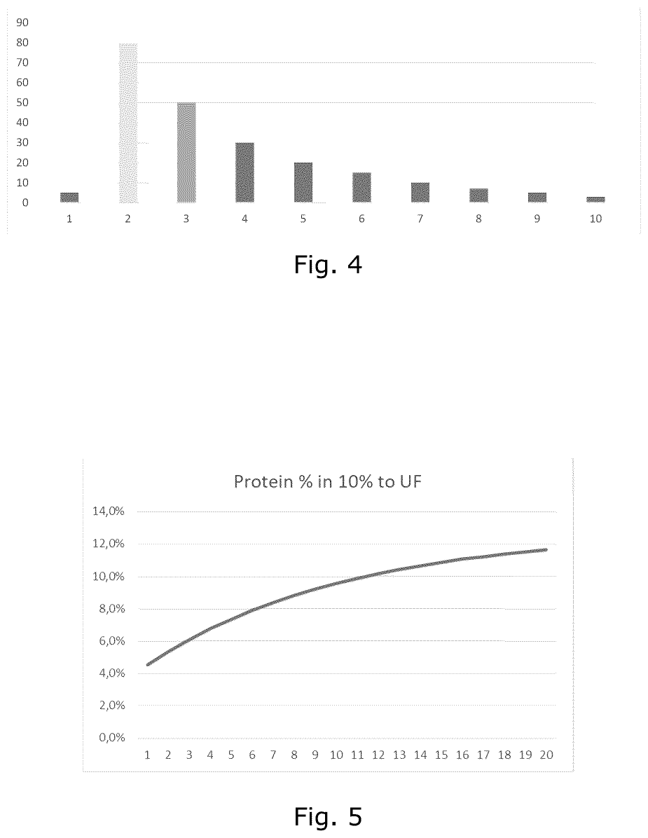

FIG. 3 shows the subsection (A) of FIG. 2 and illustrate the increase in concentration of analyte in the recirculated fraction. Even a harvest fraction is obtained from the eluate fraction in addition to the recirculated fraction, the concentration of the recirculated fraction is steadily increasing. FIG. 3 shows the development in analyte concentration over 20 cycles of part of the eluate fraction (the recirculated fraction).

FIG. 4 shows an elution profile of an analyte. Even the profile may be dependent on various factors like, the specific analyte, the ligand, the eluate buffer, the temperature etc. FIG. 4 demonstrate the general elution profile of an analyte. The operator knowing the analyte and the process conditions, may set a limit for the concentration of the analyte and when to withdraw the harvest fraction from the eluate fraction. From the elution profile shown in FIG. 4 the operator may set the limit a concentration above 35 where fractions 2 and 3 are sent to the harvest fraction and fractions 1 and 4-10 are sent to the recirculated fraction.

FIG. 5 shows the subsection (B) of FIG. 2 and illustrate the increase in concentration of analyte in the harvest fraction. As part of the eluate fraction is recircled as the recirculated fraction the concentration of analyte in the recirculated fraction increases, the concentration of analyte in the harvest fraction may gradually increase too according to the number of cycles performed.

The present invention will now be described in more detail in the following.

### DETAILED DESCRIPTION OF THE INVENTION

When conducting chromatographic separation processes of liquid mixtures, in particular of bulk mixtures such vegetable streams, plant streams or dairy steams, the productivity often becomes low since high volumes of elution buffers are used and the concentration in the eluate fraction obtained is very low. The inventors of the present invention surprisingly found that the productivity of the chromatographic process could be improved since the capacity of the elution buffer was much higher than what it was originally used for which lead to a reduced number of tanks, resulting in a reduced working space, a reduced consumption of buffer, water and chemicals for the CIP.

Hence a preferred embodiment of the present invention relates to a method for separating an analyte from a liquid mixture, said method comprises the steps of:
(i) providing at least one chromatographic support, wherein the at least one chromatographic support comprises a ligand capable of binding an the analyte in the liquid mixture;
(ii) loading a first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
   wherein at least part of the eluate fraction comprising the analyte provided in step (iv) is recirculated through the at least one chromatographic support.

In the context of the present invention the term “at least part of” relates to at least part of the eluted fraction being recirculated during operation. However, after a number of circles of recirculation the chromatographic support and/or the entire system needs to be cleaned to avid microbial contamination, preferably by cleaning in place system (CIP). Before cleaning the chromatographic support and/or the entire system the entire eluted fraction may be directed to the harvested fraction and the process may be restarted.

In an embodiment of the present invention the entire eluate fraction may be recirculated through the at least one chromatographic support for at least one cycle before at least part of the eluate fraction is removed, such as at least 2 cycles, e.g. at least 3 cycles, such as at least 4 cycles, e.g. at least 5 cycles, such as at least 6 cycles, e.g. at least 7 cycles.

Preferably, the eluate fraction may be divided into a recirculated fraction and a harvest fraction.

The recirculated fraction may be recirculated through the at least one chromatographic support resulting in a further eluate fraction. The further eluate fraction may comprise a further recirculated fraction and a further harvest fraction.

In an embodiment of the present invention recirculation of the recirculated fraction may be continued for at least 2 times/cycles, such as for at least 4 times/cycles, e.g. for at least 8 times/cycles, such as for at least 12 times/cycles, e.g. for at least 16 times/cycles, such as for at least 20 times/cycles, e.g. for at least 24 times/cycles, such as for at least 28 times/cycles, e.g. for at least 32 times/cycles, such as for at least 36 times/cycles, e.g. for at least 40 times/cycles

In a further embodiment of the present invention recirculation of the recirculated fraction may be continued for at most 45 times/cycles, such as for at most 35 times/cycles, e.g. for at most 30 times/cycles, such as for at most 25 times/cycles, e.g. for at most 20 times/cycles, such as for at most 18 times/cycles, e.g. for at most 16 times/cycles.

Preferably, recirculation of the recirculated fraction may be continued for 2-45 times/cycles, such as in the range of 10-30 times/cycles, e.g. in the range of 15-25 times/cycles, such as in the range of 18-23 times/cycles.

In an embodiment of the present invention the concentration of analyte in the recirculated fraction may be increased to a concentration in the range of 5-20% (w/w) from performing 15-25 cycles of the recirculated fraction, such as in the range of 6-17% (w/w), e.g. in the range of 7-15, such as in the range of 8-12% (w/w), e.g. in the range of 9-11% (w/w).

In an embodiment of the present invention the volume of the harvest fraction may be in the range of 2-40% (v/v) of the volume of the eluate fraction, such as in the range of 5-30% (v/v), e.g. in the range of 7-25% (v/v), such as in the range of 8-20% (v/v), e.g. in the range of 9-15% (v/v).

Preferably, the concentration of the analyte in the eluate fraction may be decisive for the part of the eluate fraction that is sent to the harvest fraction and for the part of the eluate fraction that is sent to the recirculated fraction.

The split of the eluate fraction into the harvest fraction or the recirculated fraction may be done automatically depending on the concentration of the analyte in the different parts of the eluate fraction.

Preferably, the limit, for directing part of the eluate fraction to the harvest fraction and part of the eluate fraction to the recirculated fraction, may be set by the operator. The limit may be adjusted according to the analyte to be isolated.

In an embodiment of the present invention the concentration of the analyte in the eluate fraction may be determined by an inline sensor.

Preferably, the inline sensor for determining the concentration of the analyte in the eluate fraction may automatically and continuously determine the concentration of the analyte in the eluate fraction.

In an embodiment of the present invention the concentration of the analyte in the eluate fraction, determined by the inline sensor, may be provided to a controlling device, such as a computer, which is configured to controlling one or more valves where low concentrations of analyte in the eluate fraction controls the valve to direct the eluate fraction to the recirculated fraction and when the concentration of the analyte in the eluate fraction is high the valve change direction of the eluate fraction to the harvest fraction.

In a further embodiment of the present invention the inline sensor for determining the concentration of the analyte in the eluate fraction may be an UV-sensor. Preferably a protein sensor, a protein UV-sensor.

During operation, the elution buffer may be added to isolate the analyte (step (iv), the inline sensor continuously determines the analyte concentration of the eluate fraction. The elution fraction may provide an elution profile having an initial recycling part, a harvesting part, and an ending recycling part.

The initial recycling part of the eluate buffer (forming part of the recirculated fraction) may comprise a low concentration of analyte, at some point the concentration of analyte starts to increase and the initial part of the eluate may be recycled or stored and recycled during a later elution step.

When a certain minimum concentration of the analyte has been reached the eluate fraction may form a harvest fraction which may be directed to a product tank.

After some time, the concentration of analyte in the harvest fraction decreases and when a certain minimum concentration of the analyte has been reached the eluate fraction may form a recirculated fraction.

In an embodiment of the present invention the recirculated fraction obtained before a harvest fraction and the recirculated fraction obtained after a harvest fraction may be combined and/or recycled through the at least one chromatographic support.

In the event a harvest fraction has been obtained an equal amount, or substantially equal amount, of elution buffer may be added to the recirculated fraction to account for the reduced volume.

In an embodiment of the present invention the method for separating the analyte may comprise two chromatographic supports.

Preferably, the two chromatographic supports are serially connected where an outlet of a first chromatographic support may be in fluid connection with an inlet of a second chromatographic support.

By using this concept of serially connected chromatographic supports, it is possible to overload the first column ensuring full, or substantially full, saturation of the first chromatographic support with analyte, and at the same time collecting the overload from the first chromatographic support to be captured on the second chromatographic support.

During a load of a second portion of the liquid mixture the second chromatographic support may initially be loaded ensuring full, or substantially full, saturation of the second chromatographic support with analyte, and at the same time collecting the overload from the second chromatographic support to be captured on the first chromatographic support.

In an embodiment of the present invention the load and/or overload of the chromatographic supports may be controlled by one or more inline sensors, preferably inline UV-sensors. The inline sensors may control pumps and valves responsible for loading of the at least one chromatographic support.

A further preferred embodiment of the present invention relates to a method for separating an analyte from a liquid mixture, said method comprising the step of:
(i) providing at least one chromatographic support, wherein the at least one chromatographic support comprises a ligand capable of binding the analyte in the liquid mixture;
(ii) loading a first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
(v) loading a second (or further) portion of the liquid mixture to the at least one chromatographic support;
(vi) optionally, the at least one chromatographic support is subjected to a washing step; and
(vii) adding a second (or further) elution buffer to the at least one chromatographic support, providing a second (or further) eluate fraction comprising the analyte,
(viii) optionally repeating steps (v)-(vii),
   wherein the second (and further) elution buffer added in (vii) comprises at least part of the previous eluate fraction comprising the analyte.

Preferably, the previous eluate fraction comprising the analyte may be the eluate fraction or the recirculated fraction, obtained from the previous cycle just before the present eluate fraction.

In one embodiment of the present invention the steps (v)-(vii) may be repeated until the eluate fraction is saturated or substantially saturated. Saturation of the eluate fraction may be obtained by continuously recirculating at least part of the eluate fraction from multiple cycles where part of the eluate fraction may be removed as a harvest fraction and part of the eluate fraction may be recirculated to the chromatographic support as the recirculated fraction. From continuously recirculating the recirculated fraction as elution buffer to the chromatographic support, the concentration of the analyte continuously increases, and the elution fraction become increasingly saturated with analyte.

In the context of the present invention, the term “analyte” relates to a component profile in the liquid mixture where the component has been enriched in the analyte fraction relative to the concentration of other components present in the analyte fraction.

In an embodiment of the present invention the chromatographic system comprising may be provided with a recirculation system connecting an outlet of the chromatographic system which is connected to an inlet of the chromatographic system.

The recirculation of the eluate fraction comprising the analyte provided in step (iv) may be directly recirculated from an outlet of the chromatographic system to an inlet of the chromatographic system.

In the content of the present invention, the term “directly recirculated” relates to the recirculation of the eluate fraction comprising the analyte provided in step (iv) through the at least one chromatographic support without performing a washing step of the chromatographic support, a regeneration step of chromatographic support and/or addition of further liquid mixtures.

In an embodiment of the present invention, the eluate fraction comprising the analyte provided in step (iv) may be directly recirculated through the at least one chromatographic support.

One advantage of using this direct recirculation may be that the use of chemicals in the elution buffer may be significantly reduced as the time provided allowing sufficient mass transfer of analyte from the ligand capable of binding an analyte in the liquid mixture to the elution buffer is extended.

In a further preferred embodiment of the present invention relates to a method for separating an analyte from a liquid mixture, said method comprises chromatographic separation of the analyte from a liquid mixture by subjecting the analyte bound to a ligand in the one or more chromatographic support, to an elution buffer providing an eluate fraction comprising the analyte, wherein at least part of the eluate fraction is used as elution buffer.

Fractionation of liquid mixtures may generally comprise the steps of:
a) Loading the liquid mixture to the chromatographic support;
b) optionally, washing the chromatographic support;
c) eluting the chromatographic support; and
d) regeneration/cleaning the chromatographic support.

Following regeneration/cleaning of the chromatographic support, step (d), the steps are repeated with a new load of liquid mixture; an optional new washing; a new elution, using a new load of elution buffer; and a new regeneration/cleaning of the chromatographic support, using a new load of regeneration buffer/cleaning buffer.

In the context of the present invention, the term “comprising”, which may be synonymous with the terms “including”, “containing” or “characterized by”, relates to an inclusive or open-ended listing of features and does not exclude additional, unrecited features or method steps. The term “comprising” leaves the claim open for the inclusion of unspecified ingredients even in major amounts.

In an embodiment of the present invention the elution buffer may not be a new load of elution buffer but may be a recycling of an eluate fraction obtained from the first elution step.

The recycling of the eluate fraction may be started after the second load of liquid mixture has been added to the chromatographic support and is ready for elution.

Alternatively, the recycling of the eluate fraction may be started before elution of the first load of liquid mixture has been completed but after sufficient amount of eluate fraction has been obtained. In an embodiment of the present invention the recycling of the eluate fraction may be started when at least 0.25 bed volume of eluate fraction has been obtained, such as at least 0.5 bed volume, e.g. at least 1 bed volume, such as at least 1.5 bed volume, e.g. at least 2 bed volume, such as at least 2.5 bed volume.

In a further embodiment of the present invention the recycling of the eluate fraction may be started when at least 1.25 bed volumes of elution buffer has been loaded on to the chromatographic support, such as at least 1.5 bed volumes, e.g. at least 2 bed volumes, such as at least 2.5 bed volumes, e.g. at least 3 bed volumes, such as at least 3.5 bed volumes.

In an embodiment of the present invention the eluate fraction may be recirculated from an eluate tank to the one or more chromatographic support and back to the eluate tank.

Preferably, the elution buffer comprising at least part of the eluate fraction and comprises at least 0.01 mg/ml of the analyte, such as at least 0.05 mg/ml, e.g. at least 0.1 mg/ml, such as at least 0.5 mg/ml, e.g. at least 0.75 mg/ml, such as at least 1.0 mg/ml, e.g. at least 1.5 mg/ml, such as at least 2.0 mg/ml, such as at least 2.2 mg/ml, e.g. at least 2.4 mg/ml, such as at least 2.5 mg/ml, such as at least 3.0 mg/ml, such as at least 4.0 mg/ml, e.g. at least 5.0 mg/ml, such as at least 6.0 mg/ml, such as at least 7.0 mg/ml, such as at least 8.0 mg/ml, e.g. at least 9.0 mg/ml, such as at least 10.0 mg/ml.

The harvest fraction, or part of the harvest fraction, may be subjected to a filtering process. The filtering process may comprise one or more filter-systems for separating the analyte from the elution buffer.

Preferably, the filtering process may regenerate, or substantially regenerate the elution buffer originally added.

In an embodiment of the present invention the regenerated elution buffer may comprise no, or substantially no, analyte.

Preferably, the filtering process may comprises at least one ultrafiltration process (UF-process); one or more microfiltration process (MF-process), one or more nanofiltration process (NF-process), one or more diafiltration process (DF-process) or a combination hereof.

The regenerated elution buffer obtained from the filtration process may be recirculated to the elution buffer tank and/or to the one or more chromatographic support.

Preferably, the regenerated elution buffer may be mixed with the recirculated fraction obtained from the eluate fraction.

In a further embodiment of the present invention the one or more chromatographic support may be a single chromatographic support.

The method may be applicable for both packed bed chromatographic supports and for fluidized bed chromatographic support or an expanded bed chromatographic support (EBA), or a combination hereof. Preferably, the chromatographic support may be a fluidized bed chromatographic support or an expanded bed chromatographic support (EBA).

In an embodiment of the present invention loading of the liquid mixture (and/or wash of the chromatographic support) may be done in expanded bed and addition of elution buffer may be done in reduced expanded bed (reduced relative to the expansion during loading of the liquid mixture) or packed bed, providing the eluate fraction comprising the analyte.

In addition to recycling of the eluate fraction according to the present invention the present method (or system) may involve several chromatographic supports which are coupled and configured to perform separation of the analyte using moving bed chromatography or simulated moving bed chromatography.

Simulated moving bed chromatography may be configured in different ways depending on the liquid mixture and the eluate fraction to be obtained. In a preferred embodiment of the present invention the simulated moving bed chromatography as described in EP 1 994 972 A1 may be preferred as this document relates to controlling expanded bed chromatographic supports when used in simulated moving bed chromatography. Hence, EP 1 994 972 A1 is incorporated by reference.

In an embodiment of the present invention the steps (v)-(vii) may be repeated until the eluate fraction may be saturated or substantially saturated. The level of saturation may be determined by the ability of the eluate fraction to “extract” the analyte from the chromatographic support. In the present context the eluate fraction may be saturated or substantially saturated, when more than 10% of the bound analyte remains bound to the chromatographic support, such as more than 15%, e.g. more than 20%, such as more than 25%, e.g. more than 30%, such as more than 35%, e.g. more than 40%, such as more than 45%, e.g. more than 50%.

In an embodiment of the present invention, the remaining analytes may be eluted using a new load elution buffer or an elution buffer as obtained from a further treatment of the eluate fraction

The eluate fraction may be subjected to a further treatment step providing an analyte comprising retentate and an elution comprising elution buffer permeate.

Preferably, the elution buffer permeate comprises less than 0.5 mg/ml of the analyte, such as less than 0.25 mg/ml, e.g. less than 0.01 mg/ml, such as less than 0.005 mg/ml, e.g. less than 0.001 mg/ml, such as less than 0.0005 mg/ml, e.g. less than 0.0001 mg/ml,

In an embodiment of the present invention the elution buffer permeate may be recycled to a second elution buffer tank and used as at least part of the elution buffer, preferably as a new elution buffer and/or a unsaturated elution buffer.

Preferably, the further treatment is a membrane treatment, preferably selected from one or more of ultrafiltration (UF), microfiltration (MF) and/or nanofiltration (NF).

In a preferred embodiment of the present invention the analyte may be a protein, a carbohydrate, an oligosaccharide, an enzyme, a hormone, or a growth factor; preferably the analyte is a protein or an oligosaccharide.

In order to preserve the natural character of the liquid mixture, the liquid mixture may not be subjected to pasteurisation.

In a further preferred embodiment of the present invention, the liquid mixture may be a dairy source or a plant extract.

The dairy source may be selected from the group consisting of milk, whole milk, skimmed milk, milk concentrates, reconstituted milk powder, non-pasteurised milk, micro-filtrated milk, pH-adjusted milk, pre-treated dairy source, and whey.

A characteristic feature of the dairy source may be that the dairy source has not been subjected to casein precipitation, removal of casein micelles, and/or removal of the casein aggregates, prior to the separation of the analyte.

In a further embodiment of the present invention the dairy source may be obtained from a ruminant, such as a cow, a goat, a sheep, or a buffalo; or from another domesticated non-human mammal.

In order to quickly process the liquid mixture increased loading speed may be preferred. Hence, in an embodiment of the present invention the liquid mixture may be loaded on to the chromatographic support at a flow-rate in the range of 1-50 cm/min; preferably in the range of 5-30 cm/min; more in the range of 10-25 cm/min; even more preferably, in the range of 15-20 cm/min.

In the present context, the term “chromatography support” relates to any kind of container comprising an adsorbent, which can be supplied with at least one inlet for loading the liquid mixture according to the present invention and at least one outlet for obtaining the eluate fraction when subjected to an elution buffer.

In a preferred embodiment of the present invention, the chromatographic support may comprise an adsorbent.

Before the liquid mixture may be contacted with the adsorbent an initial, but optional, step in the method of the invention may involves equilibration of the adsorbent. Such equilibration may be done by using an equilibration liquid. PH of the equilibration liquid may vary dependent on the type of liquid mixture, the ligand used, and/or the eluate fraction to be obtained.

In the present context the term “adsorbent” relates to the entire bed present in the chromatographic support and is responsible for retaining the analyte. The analyte may be retained by coupling of a suitable ligand capable of binding specifically to the analyte present in the liquid mixture.

In an embodiment of the present invention, the adsorbent may preferably comprise individual particles. In the present context, the term “adsorbent particle” is used interchangeably with the term “particle” and relates to the individual single particles which makes up the adsorbent.

When the adsorbent, in the form of particles, is used in Expanded bed Adsorption several features, such as the flow rate, the size of the particles and the density of the particles may have influence on the expansion of the fluid bed and the separation of the proteins. It is important to control the degree of expansion in such a way to keep the adsorbent particles inside the column, but at the same time optimize the flow rate.

The degree of expansion may be determined as H/HO, where “HO” is the height of the bed in packed bed mode and “H” is the height of the bed in expanded mode. In an embodiment of the present invention, the degree of expansion H/HO is in the range of 1.1-10 e.g. 1.0-6, such as 1.2-5, e.g. 1.3-5, such as 1.5-4, e.g. 4-6, such as 3-5, e.g. 3-4, such as 4-6.

In another embodiment of the present invention the degree of expansion H/HO is at least 1.1, such as at least 1.5, e.g. at least 2, such as at least 2.5, e.g. at least 3, such as at least 3.5, e.g. at least 4, such as at least 4.5, e.g. at least 5, such as at least 5.5, e.g. at least 6, such as at least 10.

Furthermore, the density of the EBA adsorbent particle may be highly significant for the applicable flow rates in relation to the maximal degree of expansion of the adsorbent bed possible inside a typical EBA column (e.g. H/HO max 3-5) and must be at least 1.3 g/ml, more preferably at least 1.5 g/ml, still more preferably at least 1.8 g/ml, even more preferably at least 2.0 g/ml, most preferably at least 2.3 g/ml, in order to enable a high productivity of the method.

The density of the EBA adsorbent particle is meant to be the density of the adsorbent particle in it's fully solvated (e.g. hydrated) state as opposed to the density of a dried adsorbent particle.

The high density of the adsorbent particle may be, to a great extent, achieved by inclusion of a certain proportion of a dense non-porous core materials, preferably having a density of at least 4.0 g/ml, such as at least 10 g/ml, e.g. at least 16 g/ml, such as at least 25 g/ml. Typically, the non-porous core material has a density in the range of about 4.0-25 g/ml, such as about 4.0-20 g/ml, e.g. about 4.0-16 g/ml, such as 12-19 g/ml, e.g. 14-18 g/ml, such as about 6.0-15.0 g/ml, e.g. about 6.0-16 g/ml.

The adsorbent particles may be constituted by a number of chemically derivatised porous materials having the necessary density and binding capacity to operate at the given flow rates per se. The particles may be either of the conglomerate type, as described in WO92/00799, having at least two non-porous cores surrounded by a porous polymeric base matrix, or of the pellicular type having a single non-porous core surrounded by a porous polymeric base matrix.

The adsorbent may comprise a porous polymeric base matrix having the one or more mixed-mode ligands covalently attached. Preferably, the porous polymeric base matrix may be a porous organic polymeric base matrix. In an embodiment of the present invention, the adsorbent may comprise a dense non-porous core material surrounded by the porous polymeric base matrix.

The person skilled in the art knows various non-porous core materials and various porous polymeric base matrix. Examples of non-porous core materials and porous polymeric base matrixes may be found in WO 2010/037736. The skilled person also knows methods of preparing the adsorbent according to the present invention, such methods of preparing the adsorbent may be described in WO 2010/03776, EP 0 538 350 or WO 97/17132.

In order to conduct the method of the present invention, a chromatographic system may be provided supporting the method.

Hence, in a preferred embodiment of the present invention a chromatographic system may be provided comprising one or more chromatographic support, the one or more chromatographic support comprises at least one inlet and at least one outlet, the at least one outlet is in fluid connection with at least one eluate tank, wherein the at least one eluate tank comprises a recirculation system in fluid connection with the at least one inlet of the one or more chromatographic support.

Preferably the at least one outlet may, in addition to being in fluid connection with at least one eluate tank, also being in fluid connection with at least one harvest tank for receiving the harvest fraction.

The harvest tank may be in fluid connection with at least one filter-system for removing at least part of the eluate buffer from the analyte.

Preferably, the filtering system comprises at least one ultra-filter system (UF-system); one or more micro-filter system (MF-system), one or more nano-filter system (NF-system), one or more diafiltration system (DF-system) or a combination hereof.

In an embodiment of the present invention the at least one filter-system is in fluid contact with the at least one inlet of the one or more chromatographic support, thus providing a recirculation system in fluid connection with the at least one inlet of the one or more chromatographic support.

In a further preferred embodiment of the present invention relates to a chromatographic system consist essentially of one or more chromatographic support, the one or more chromatographic support comprises at least one inlet and at least one outlet, the at least one outlet is in fluid connection with at least one eluate tank, and at least one harvest tank for receiving the harvest fraction, wherein the at least one eluate tank comprises a recirculation system in fluid connection with the at least one inlet of the one or more chromatographic support and wherein the harvest tank may be in fluid connection with at least one filter-system for removing at least part of the eluate buffer from the analyte and said at least one filter-system is in fluid connection with the at least one inlet of the one or more chromatographic support.

In a further preferred embodiment of the present invention relates to a chromatographic system consist essentially of one or more chromatographic support, the one or more chromatographic support comprises at least one inlet and at least one outlet, the at least one outlet is in fluid connection with at least one eluate tank, wherein the at least one eluate tank comprises a recirculation system in fluid connection with the at least one inlet of the one or more chromatographic support.

In the context of the present invention, the term “consisting essentially of”, relates to a limitation of the scope of a claim to the specified features or steps and those features or steps, not mentioned and that do not materially affect the basic and novel characteristic(s) of the claimed invention.

In the present context the term “fluid connection” relates to a connection that allows transport of liquid.

Preferably, the recirculation system is provided with a valve capable of providing an open access from the eluate tank to a buffer tank or to the at least one inlet of the chromatographic support.

In an embodiment of the present invention the recirculation system is provided with a pump capable of directing the eluate fraction from the eluate tank to a buffer tank and/or to the at least one inlet of the chromatographic support.

In an embodiment of the present invention the chromatographic system comprises an elution buffer tank in fluid connection with the at least one inlet of the one or more chromatographic support.

In a further embodiment of the present invention the one or more chromatographic support may be a single chromatographic support.

The recycling system provided by the present invention may be applicable for both packed bed chromatographic supports and for fluidized bed chromatographic support or expanded bed chromatographic support (EBA). Preferably, the chromatographic support may be a fluidized bed chromatographic support or an expanded bed chromatographic support (EBA). Even more preferably, the chromatographic support may be an expanded bed chromatographic support (EBA).

Generally, the Expanded Bed Adsorption is well known to the person skilled in the art, and the method described in the present invention may be adapted to the processes described in WO 92/00799, WO 92/18237, WO 97/17132, WO 00/57982 or WO 98/33572, which are all incorporated by reference.

In addition to recycling of the eluate fraction according to the present invention the present system may involve several chromatographic supports which are coupled and configured to perform separation of the analyte using moving bed chromatography or simulated moving bed chromatography as described previously.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1 Isolation of Lactoperoxidase (LP) from Skimmed Milk

Experiments were performed to isolate lactoperoxidase directly from skimmed milk using a chromatographic support comprising expanded bed adsorption chromatography (EBA) using the adsorbent XpressLine Pro A, UpFront Chromatography A/S.

The adsorbent comprises an aromatic acid ligand and generally binds proteins in the pH-range of pH 4 to 6 and the bound proteins are released by increasing the pH to 9-10 in an elution buffer.

The experiments were performed in an expanded bed column (O=40 cm) with a linear flow rate of 15 cm/min and an expansion of the bed of 1.5.

The chromatographic support was operated in three circles, the first circle 2000 L skimmed milk was loaded in the chromatographic support, in the second circle 2800 L skimmed milk, and in third circle 3600 L skimmed milk was loaded on the chromatographic support.

The chromatographic support was after loading washed with demineralized water.

The analyte of interest, lactoperoxidase, was eluted from the resin with 10 ml 20 mN sodium hydroxide.

The content of protein in each fraction was determined by standard protein assay and the following results were found:

| | Correlated to standard volume | |
|---|---|---|
| | of 2000 L (mg/ml) | Relative value to 1^{st} circle |
| TEST 1 | | |
| 1 circle | 1.154 | 1 |
| 2 circles | 2.216 | 1.92 |
| 3 circles | 3.420 | 2.96 |
| TEST 2 | | |
| 1 circle | 1.830 | 1 |
| 2 circles | 3.624 | 1.98 |

Thus, the experiment shows that a high increase in the analyte concentration of the eluate fraction by recycling the eluate fraction to the elution buffer, resulting in a significant decrease the space requirements, the buffer consumption, the water consumption and chemical consumption during CIP, and/or the time at the membrane, and hence a significant cost reduction may be obtained.

### REFERENCES

EP 1 994 972 A1
WO 92/00799 A1
WO 92/18237 A1
WO 97/17132 A1
WO 00/57982 A1
WO 98/33572 A1
WO 2010/03776
EP 0 538 350
WO 97/17132

1. A method for separating an analyte from a liquid mixture, said method comprises the steps of:
(i) providing at least one chromatographic support, wherein the at least one chromatographic support comprises a ligand capable of binding the analyte in the liquid mixture;
(ii) loading a first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
wherein at least part of the eluate fraction comprising the analyte provided in step (iv) is recirculated through the at least one chromatographic support.

2. The method according to claim 1, wherein the eluate fraction divided into a recirculated fraction and a harvest fraction.

3. The method according to claim 2, wherein the concentration of the analyte in the eluate fraction is decisive for the part of the eluate fraction that is sent to the harvest fraction and for the part of the eluate fraction that is sent to the recirculated fraction.

4. The method according to claim 3, wherein the concentration of the analyte in the eluate fraction is determined by an inline sensor.

5. The method according to claim 1, wherein the method for separating the analyte comprises two chromatographic supports.

6. A method for separating an analyte from a liquid mixture, said method comprising the step of:
(i) providing at least one chromatographic support, wherein the at least one chromatographic support comprises a ligand capable of binding the analyte in the liquid mixture;
(ii) loading a first portion of the liquid mixture to the at least one chromatographic support;
(iii) optionally, the at least one chromatographic support is subjected to a washing step; and
(iv) adding a first elution buffer to the at least one chromatographic support, providing an eluate fraction comprising the analyte,
(v) loading a second (or further) portion of the liquid mixture to the at least one chromatographic support;
(vi) optionally, the at least one chromatographic support is subjected to a washing step; and
(vii) adding a second (or further) elution buffer to the at least one chromatographic support, providing a second (or further) eluate fraction comprising the analyte,
(viii) optionally repeating steps (v)-(vii),
wherein the second (and further) elution buffer added in (vii) comprises at least part of the previous eluate fraction comprising the analyte.

7. A method for separating an analyte from a liquid mixture, said method comprises chromatographic separation of the analyte from a liquid mixture by subjecting the analyte bound to a ligand in the one or more chromatographic support, to an elution buffer providing an eluate fraction comprising the analyte, wherein at least part of the eluate fraction is used as elution buffer.

8. The method according to claim 1, wherein the elution buffer comprising at least part of the eluate fraction and comprises at least 0.01 mg/ml of the analyte, such as at least 0.05 mg/ml, e.g. at least 0.1 mg/ml, such as at least 0.5 mg/ml, e.g. at least 0.75 mg/ml, such as at least 1.0 mg/ml, e.g. at least 1.5 mg/ml, such as at least 2.0 mg/ml, such as at least 2.2 mg/ml, e.g. at least 2.4 mg/ml, such as at least 2.5 mg/ml, such as at least 3.0 mg/ml, such as at least 4.0 mg/ml, e.g. at least 5.0 mg/ml, such as at least 6.0 mg/ml, such as at least 7.0 mg/ml, such as at least 8.0 mg/ml, e.g. at least 9.0 mg/ml, such as at least 10.0 mg/ml.

9. A chromatographic system comprising one or more chromatographic support, the one or more chromatographic support comprises at least one inlet and at least one outlet, the at least one outlet is in fluid connection with at least one eluate tank, wherein the at least one eluate tank comprises a recirculation system in fluid connection with the at least one inlet of the one or more chromatographic support.

10. A chromatographic system consist essentially of one or more chromatographic support, the one or more chromatographic support comprises at least one inlet and at least one outlet, the at least one outlet is in fluid connection with at least one eluate tank, and at least one harvest tank for receiving the harvest fraction, wherein the at least one eluate tank comprises a recirculation system in fluid connection with the at least one inlet of the one or more chromatographic support and wherein the harvest tank may be in fluid connection with at least one membrane-system for removing at least part of the eluate buffer from the analyte and said at least one membrane-system is in fluid connection with the at least one inlet of the one or more chromatographic support.
